(19) United States
(12) Patent Application Publication
(10) Pub. No.: US 2026/0166984 A1
(43) Pub. Date: Jun. 18, 2026

(54) VEHICLE

(71) Applicant: SUBARU CORPORATION, Tokyo (JP)

(72) Inventors: Shinichiro NAKAHIRA, Tokyo (JP); Takeshi TSUDA, Tokyo (JP); Norio SUGIURA, Tokyo (JP)

(21) Appl. No.: 19/531,260

(22) Filed: Feb. 5, 2026

Related U.S. Application Data
(63) Continuation of application No. PCT/JP2023/033976, filed on Sep. 19, 2023.

(51) Int. Cl. B60K 6/445; B60K 6/26

(52) U.S. Cl. CPC B60K 6/445; B60K 6/26

(57) ABSTRACT

A vehicle includes a first motor generator, a second motor generator, a first power conversion apparatus, a second power conversion apparatus, a connection port, a planetary mechanism, an engine, a clutch, and wheels. The first power conversion apparatus and the second power conversion apparatus convert powers generated by the first motor generator and the second motor generator, respectively, into single-phase alternating-current powers and output the single-phase alternating-current powers. The connection port includes a first voltage terminal, a second voltage terminal, and a neutral terminal and is electrically connected to wiring outside the vehicle. The planetary mechanism includes a sun gear, a ring gear, a planetary pinion, and a carrier. The engine is connected to the carrier. When the second motor generator is caused to generate the power in a state in which the vehicle is not running, the clutch is caused to be in a disengaged state.

### CROSS REFERENCE TO RELATED APPLICATIONS

This application is continuation of International Application No. PCT/JP2023/033976, filed on Sep. 19, 2023, the entire contents of which are hereby incorporated by reference.

### BACKGROUND

The disclosure relates to a vehicle.

For example, Japanese Unexamined Patent Application Publication (JP-A) No. 2016-74316 discloses a vehicle including an engine, a first motor generator, and a second motor generator. JP-A No. 2016-74316 indicates that power generated by the first motor generator, which mainly generates power in accordance with the operation of the engine, is capable of being supplied to the outside of the vehicle.

### SUMMARY

An aspect of the disclosure provides a vehicle including a first motor generator, a second motor generator, a first power conversion apparatus, a second power conversion apparatus, a connection port, a planetary mechanism, an engine, a clutch, and wheels. The first power conversion apparatus is configured to convert power generated by the first motor generator into single-phase alternating-current power and output the single-phase alternating-current power. The second power conversion apparatus is provided independently of the first power conversion apparatus and is configured to convert power generated by the second motor generator into single-phase alternating-current power and output the single-phase alternating-current power. The connection port includes a first voltage terminal, a second voltage terminal, and a neutral terminal and is configured to electrically connected to wiring outside the vehicle. The planetary mechanism includes a sun gear, a ring gear, a planetary pinion, and a carrier coupled to the planetary pinion. The engine is configured to be connected to the carrier. A first output terminal of two output terminals of the first power conversion apparatus is configured to be electrically connected to the first voltage terminal of the connection port and a second output terminal of the two output terminals of the first power conversion apparatus is configured to be electrically connected to the neutral terminal of the connection port. A first output terminal of two output terminals of the second power conversion apparatus is configured to be electrically connected to the second voltage terminal of the connection port and a second output terminal of two output terminals of the second power conversion apparatus is configured to be electrically connected to the neutral terminal of the connection port. The second motor generator is connected to the ring gear and is connected to a first end of the clutch. A second end of the clutch is connected to the wheels. The second motor generator is configured to generate the power in accordance with an operation of the engine. The clutch is configured to, when the second motor generator is caused to the power in a state in which the vehicle is not running, be caused to be in a disengaged state.

An aspect of the disclosure provides a vehicle including a first motor generator, a second motor generator, a first power conversion apparatus, a second power conversion apparatus, a connection port, a planetary mechanism, an engine, and a decelerator. The first power conversion apparatus is configured to convert power generated by the first motor generator into single-phase alternating-current power and output the single-phase alternating-current power. The second power conversion apparatus is provided independently of the first power conversion apparatus and is configured to convert power generated by the second motor generator into single-phase alternating-current power and output the single-phase alternating-current power. The connection port includes a first voltage terminal, a second voltage terminal, and a neutral terminal and is configured to electrically connected to wiring outside the vehicle. The planetary mechanism includes a sun gear, a ring gear, a planetary pinion, and a carrier coupled to the planetary pinion. The engine is configured to be connected to the carrier. The decelerator is configured to be connected to the ring gear. A first output terminal of two output terminals of the first power conversion apparatus is configured to be electrically connected to the first voltage terminal of the connection port and a second output terminal of the two output terminals of the first power conversion apparatus is configured to be electrically connected to the neutral terminal of the connection port. A first output terminal of two output terminals of the second power conversion apparatus is configured to be electrically connected to the second voltage terminal of the connection port and a second output terminal of the two output terminals of the second power conversion apparatus is configured to be electrically connected to the neutral terminal of the connection port. The first motor generator is connected to the sun gear. The second motor generator is connected to the ring gear via the decelerator. The first motor generator and the second motor generator configured to generate the power in accordance with an operation of the engine. A gear ratio of the decelerator is set to a value at which a difference between a maximum value of the power which the first motor generator is capable of generating and a maximum value of the power which the second motor generator is capable of generating is substantially decreased.

An aspect of the disclosure provides a vehicle including a first motor generator, a second motor generator, a first power conversion apparatus, a second power conversion apparatus, a connection port, a first voltage sensor, a second voltage sensor, and a control unit. The first power conversion apparatus is configured to convert power generated by the first motor generator into single-phase alternating-current power and output the single-phase alternating-current power. The second power conversion apparatus is provided independently of the first power conversion apparatus and is configured to convert power generated by the second motor generator into single-phase alternating-current power and output the single-phase alternating-current power. The connection port includes a first voltage terminal, a second voltage terminal, and a neutral terminal and is configured to be electrically connected to wiring outside the vehicle. The first voltage sensor is configured to perform detection of voltage between the neutral terminal and the first voltage terminal. The second voltage sensor is configured to perform detection of voltage between the neutral terminal and the second voltage terminal. A first output terminal of two output terminals of the first power conversion apparatus is configured to be electrically connected to the first voltage terminal of the connection port and a second output terminal of the two output terminals of the first power conversion apparatus is configured to be electrically connected to the neutral terminal of the connection port. A first output terminal of two output terminals of the second power conversion apparatus is configured to be electrically connected to the second voltage terminal of the connection port and a second output terminal of the two output terminals of the second power conversion apparatus is configured to be electrically connected to the neutral terminal of the connection port. The first power conversion apparatus includes a first alternating current-direct current converter, a first direct current-direct current converter, and a first direct current-alternating current converter. The first alternating current-direct current converter is configured to perform conversion of alternating-current generated power of the first motor generator into direct current power. The first direct current-direct current converter is configured to perform conversion of the direct current power after the conversion by the first alternating current-direct current converter into direct current power of different voltage. The first direct current-alternating current converter is configured to perform conversion of the direct current power after the conversion by the first direct current-direct current converter into single-phase alternating-current power and is configured to supply the single-phase alternating-current power after the conversion between the neutral terminal and the first voltage terminal. The second power conversion apparatus includes a second alternating current-direct current converter, a second direct current-direct current converter, and a second direct current-alternating current converter. The second alternating current-direct current converter is configured to perform conversion of alternating-current generated power of the second motor generator into direct current power. The second direct current-direct current converter is configured to perform conversion of the direct current power after the conversion by the second alternating current-direct current converter into direct current power of different voltage. The second direct current-alternating current converter is configured to perform conversion of the direct current power after the conversion by the second direct current-direct current converter into single-phase alternating-current power and is configured to supply the single-phase alternating-current power after the conversion between the neutral terminal and the second voltage terminal. The control unit includes one or more processors and one or more memories coupled to the one or more processors. The one or more processors are configured to control one or both of the first direct current-direct current converter and the second direct current-direct current converter so that an effective value of voltage between the neutral terminal and the first voltage terminal is substantially equal to an effective value of voltage between the neutral terminal and the second voltage terminal based on a result of the detection by the first voltage sensor and a result of the detection by the second voltage sensor.

An aspect of the disclosure provides a vehicle including a first motor generator, a second motor generator, a first power conversion apparatus, a second power conversion apparatus, a connection port, and a control unit. The first power conversion apparatus is configured to convert power generated by the first motor generator into single-phase alternating-current power and output the single-phase alternating-current power. The second power conversion apparatus is provided independently of the first power conversion apparatus and is configured to convert power generated by the second motor generator into single-phase alternating-current power and output the single-phase alternating-current power. The connection port includes a first voltage terminal, a second voltage terminal, and a neutral terminal and is configured to electrically connected to wiring outside the vehicle. A first output terminal of two output terminals of the first power conversion apparatus is configured to be electrically connected to the first voltage terminal of the connection port and a second output terminal of the two output terminals of the first power conversion apparatus is configured to be electrically connected to the neutral terminal of the connection port. A first output terminal of two output terminals of the second power conversion apparatus is configured to be electrically connected to the second voltage terminal of the connection port and a second output terminal of the two output terminals of the second power conversion apparatus is configured to be electrically connected to the neutral terminal of the connection port. The control unit includes one or more processors and one or more memories coupled to the one or more processors. The one or more processors are configured to perform processes including: determining whether power of first in-between between the neutral terminal and the first voltage terminal is unbalanced with power of second in-between between the neutral terminal and the second voltage terminal; and when the power of the first in-between is unbalanced with the power of the second in-between, controlling one or both of generated power of the first motor generator and generated power of the second motor generator so that a ratio between the generated power of the first motor generator and the generated power of the second motor generator is substantially equal to a ratio between the power of the first in-between and the power of the second in-between.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic diagram illustrating the configuration of a power supply system to which a vehicle according to an embodiment is applied;

FIG. 2 is a block diagram illustrating a mechanical connection configuration of the vehicle;

FIG. 3 is a colinear diagram indicating the output relationship among an engine, a first motor generator, and a second motor generator;

FIG. 4 is a block diagram illustrating an electrical configuration of the vehicle;

FIG. 5 is a diagram describing how to perform control if it is determined that the power at a first voltage terminal side is unbalanced with the power at a second voltage terminal side;

FIG. 6 is a flowchart describing an operational flow of a power controller; and

FIG. 7 is a flowchart describing an operational flow of power supply control.

### DETAILED DESCRIPTION

However, with the technique in JP-A No. 2016-74316, although the power is capable of being supplied to the outside of the vehicle, a sufficient amount of power is not supplied to the outside of the vehicle.

Accordingly, it is desirable to provide a vehicle capable of supplying a sufficient amount of power.

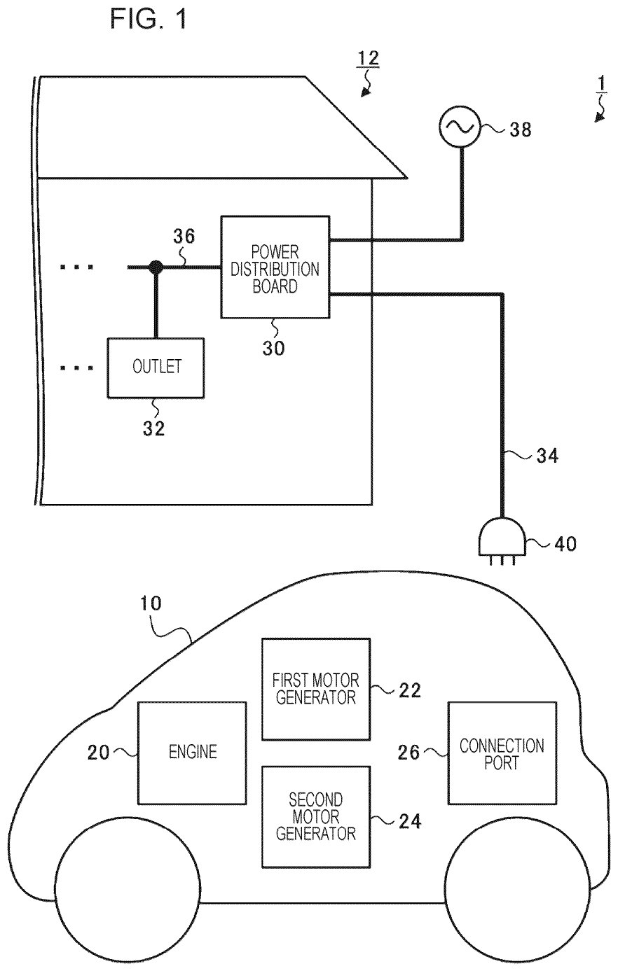

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. FIG. 1 is a schematic diagram illustrating the configuration of a power supply system 1 to which a vehicle 10 according to an embodiment is applied. The power supply system 1 includes the vehicle 10 and a local facility 12.

The vehicle 10 includes an engine 20, a first motor generator 22, a second motor generator 24, and a connection port 26.

The engine 20 is a driving source of the vehicle 10. The first motor generator 22 and the second motor generator 24 are coupled to the engine 20. The first motor generator 22 generates power mainly in accordance with the operation of the engine 20. The second motor generator 24 mainly serves as the driving source of the vehicle 10 along with the engine 20. As described above, the vehicle 10 is a hybrid electric vehicle having the engine 20 and the second motor generator 24 as the driving sources.

Since the first motor generator 22 is mainly for power generation and the second motor generator 24 is mainly for driving, as described above, various specifications including rated power output of the first motor generator 22 are normally different from those of the second motor generator 24. The rated power output of the first motor generator 22 may be made substantially equal to that of the second motor generator 24, if possible.

In the vehicle 10, the second motor generator 24 is also capable of generating power in accordance with the operation of the engine 20, like the first motor generator 22, which will be described below.

The connection port 26 is electrically connected to the first motor generator 22 and the second motor generator 24. The connection port 26 is also electrically connected to an on-vehicle battery (not illustrated). The connection port 26 is electrically connectable to wiring outside the vehicle 10. The vehicle 10 is capable of single-phase three-wire output to the wiring outside the vehicle 10 via the connection port 26, which will be described below. The vehicle 10 will be described in detail below.

The local facility 12 is provided in, for example, the premise of a consumer. The local facility 12 includes a power distribution board 30, an outlet 32, and a power feeding cable 34. The power distribution board 30 and the outlet 32 are provided in a building of the premise.

A local wiring 36 and a power system 38 are electrically connected to the power distribution board 30. The outlet 32 is connected to the power distribution board 30 via the local wiring 36. Any electric equipment of the consumer is capable of being electrically connected to the outlet 32. The power system 38 is connected to the power distribution board 30 using a single-phase three-wire power distribution method.

The power feeding cable 34 is connected to the power distribution board 30. The power feeding cable 34 is provided with a connector 40 at its tip. The connector 40 is connectable to the connection port 26 of the vehicle 10. The power feeding cable 34 and the connector 40 include an electric wire configuration corresponding to the single-phase three-wire method.

Upon connection of the connector 40 of the power feeding cable 34 to the connection port 26 of the vehicle 10, the first motor generator 22 and the second motor generator 24 are electrically connected to the local wiring 36. In the power supply system 1, the vehicle 10 serves as a distributed power supply apparatus and power generated in the vehicle 10 is capable of being supplied to the local wiring 36 outside the vehicle 10. The vehicle 10 supplies the power generated in the vehicle 10 to the local wiring 36 in a state in which the vehicle 10 is not running, that is, in a stopped state.

The vehicle 10 is capable of receiving power from the outside of the vehicle 10 via the power feeding cable 34 to charge the on-vehicle battery.

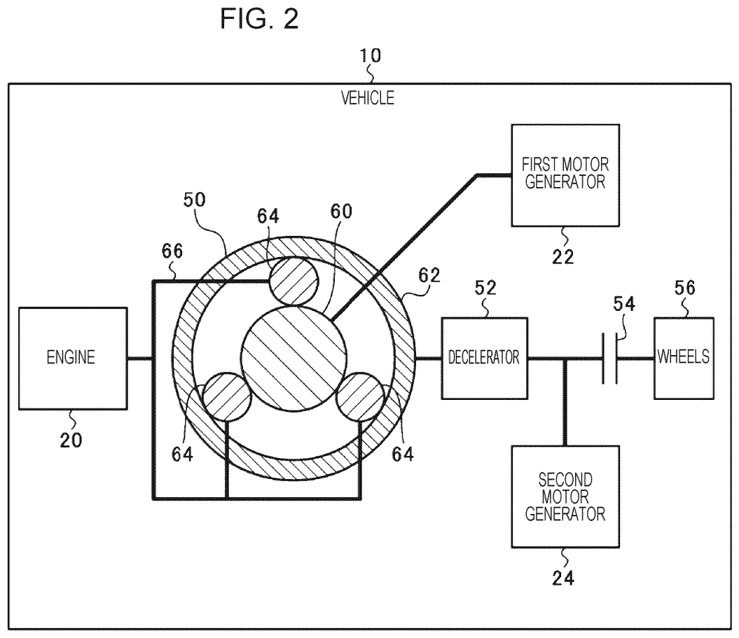

FIG. 2 is a block diagram illustrating a mechanical connection configuration of the vehicle 10. The vehicle 10 further includes a planetary mechanism 50, a decelerator 52, a clutch 54, and wheels 56. The planetary mechanism 50 includes a sun gear 60, a ring gear 62, planetary pinions 64, and a carrier 66.

The sun gear 60 is formed in, for example, a disk shape. The ring gear 62 is formed in, for example, a ring shape. The sun gear 60 is positioned inside the ring gear 62 and is disposed concentrically with the ring gear 62. The multiple planetary pinions 64 are provided between the sun gear 60 and the ring gear 62 and are engaged with the sun gear 60 and the ring gear 62. The planetary pinions 64 revolve around the outer periphery of the sun gear 60 while rotating. The carrier 66 is coupled to the rotation shaft of each planetary pinion 64. The carrier 66 converts the revolution of the planetary pinions 64 into the rotation of the carrier 66.

The engine 20 is connected to the carrier 66. The first motor generator 22 is connected to the sun gear 60. The decelerator 52 is connected to the ring gear 62. The second motor generator 24 is connected to the ring gear 62 via the decelerator 52.

The decelerator 52 includes, for example, a gear mechanism. The decelerator 52 performs conversion of the rotation speed between an input end of the decelerator 52 and an output end of the decelerator 52. The decelerator 52 will be described in detail below.

A one-side end of the clutch 54 is connected to the second motor generator 24 and the decelerator 52. The other-side end of the clutch 54 is coupled to the wheels 56. In other words, the ring gear 62 is coupled to the wheels 56 via the decelerator 52 and the clutch 54. The clutch 54 permits transmission of driving force in an engaged state and shuts off the transmission of the driving force in a disengaged state. For example, when the clutch 54 is in the engaged state, the driving force output from the engine 20 is transmitted to the wheels 56 via the carrier 66, the planetary pinions 64, the ring gear 62, the decelerator 52, and the clutch 54.

The second motor generator 24 is coupled to the engine 20 via the decelerator 52, the ring gear 62, the planetary pinions 64, and the carrier 66. Accordingly, the second motor generator 24 is capable of generating the power in accordance with the operation of the engine 20.

If the clutch 54 is in the engaged state when the vehicle 10 is caused to serve as the distributed power supply apparatus to supply the power from the vehicle 10 to the local wiring 36, the driving force of the engine 20 is transmitted to the wheels 56 via the clutch 54 to cause the vehicle 10 to run. In this case, it is not possible to appropriately perform the supply of the power from the vehicle 10 to the local wiring 36.

In order to resolve this problem, the clutch 54 is caused to be in the disengaged state in the supply of the power from the vehicle 10 to the local wiring 36. In other words, in the vehicle 10, when the second motor generator 24 is caused to generate the power with power from the engine 20 in the state in which the vehicle 10 is not running, the clutch 54 is caused to be in the disengaged state. This enables the supply of the power from the vehicle 10 to the local wiring 36 to be appropriately performed.

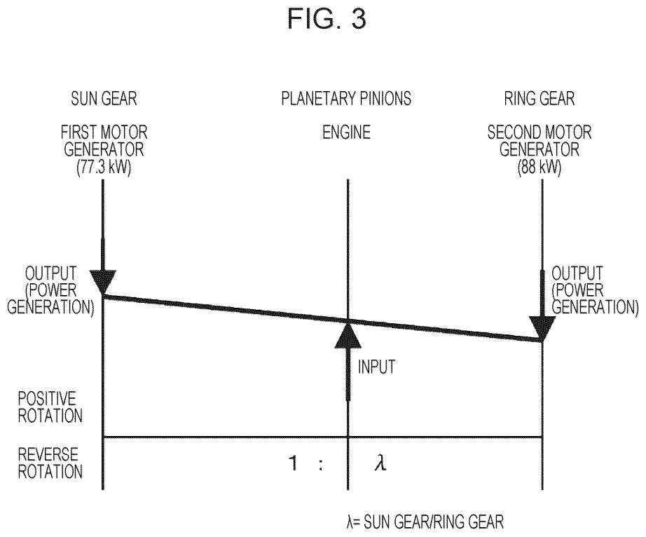

FIG. 3 is a colinear diagram indicating the output relationship among the engine 20, the first motor generator 22, and the second motor generator 24. An example is illustrated in FIG. 3 in a case in which the first motor generator 22 and the second motor generator 24 are caused to generate the power with the power from the engine 20. It is assumed in the example in FIG. 3 that the rated power output of the first motor generator 22 is 77.3 kW and the rated power output of the second motor generator 24 is 88 kW.

On the horizontal axis of the colinear diagram, the ratio between the spacing between the planetary pinions 64 and the sun gear 60 and the spacing between the planetary pinions 64 and the ring gear 62 indicates a gear ratio of the planetary mechanism 50, which is equal to “1:λ”. “λ” indicates “the number of gears of the sun gear/the number of gears of the ring gear”. The height of the vertical axis of the colinear diagram indicates the rotation speed.

As indicated in FIG. 3, the first motor generator 22 and the second motor generator 24 operate at the rotation speed in a balanced state corresponding to the gear ratio of the planetary mechanism 50. Since the rotation speed of each of the first motor generator 22 and the second motor generator 24 is related to generated power of each thereof, the first motor generator 22 and the second motor generator 24 output the generated power in the balanced state corresponding to the gear ratio of the planetary mechanism 50.

As described above, in the power supply system 1, both the first motor generator 22 and the second motor generator 24 are caused to generate the power to transmit the generated power to the outside of the vehicle 10. Accordingly, the generated power of both the first motor generator 22 and the second motor generator 24 is desirably increased as much as possible. Consequently, in a design stage of the planetary mechanism 50, the gear ratio of the planetary mechanism 50 is set to a value at which both the maximum value of the power which the first motor generator 22 is capable of generating and the maximum value of the power which the second motor generator 24 is capable of generating are increased.

It is desirable to make the generated power of the first motor generator 22 substantially equal to the generated power of the second motor generator 24 in the present embodiment, which will be described in detail below.

Accordingly, the decelerator 52 is provided between the ring gear 62 and the second motor generator 24 in the vehicle 10. In the design stage of the vehicle 10, the gear ratio of the decelerator 52 is set to a value at which the difference between the maximum value of the power which the first motor generator 22 is capable of generating and the maximum value of the power which the second motor generator 24 is capable of generating is substantially decreased.

The decelerator 52 works so that λ in the colinear diagram is corrected with the gear ratio of the decelerator 52. Accordingly, setting the gear ratio of the decelerator 52 to a specific value enables the value of λ after the correction to be close to one (“1”). In other words, setting the gear ratio of the decelerator 52 to a specific value enables the output balance between the maximum value of the power which the first motor generator 22 is capable of generating and the maximum value of the power which the second motor generator 24 is capable of generating to be substantially equalized.

The gear ratio of the decelerator 52 is not limited to the aspect in which the gear ratio of the decelerator 52 is set to a value at which the output balance between the maximum value of the power which the first motor generator 22 is capable of generating and the maximum value of the power which the second motor generator 24 is capable of generating is substantially equalized. The gear ratio of the decelerator 52 may be set to any value at which at least the output balance comes closer to the equalization, compared with that of an aspect in which the decelerator 52 is not provided.

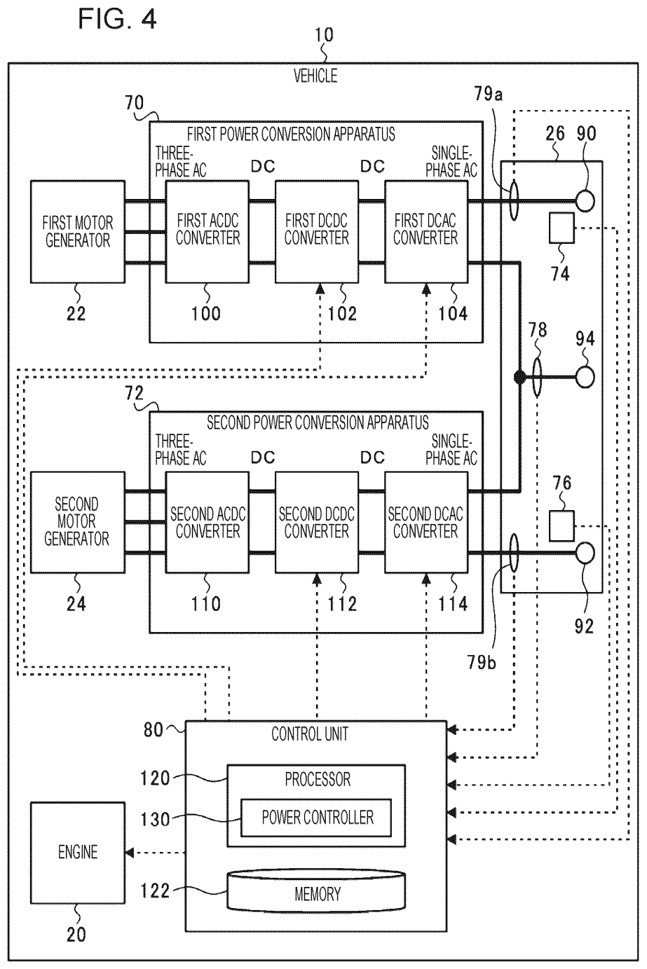

FIG. 4 is a block diagram illustrating an electrical configuration of the vehicle 10. Direct current may be hereinafter denoted by DC and alternating current may be hereinafter denoted by AC.

The vehicle 10 further includes a first power conversion apparatus 70, a second power conversion apparatus 72, a first voltage sensor 74, a second voltage sensor 76, a neutral line current sensor 78, a first current sensor 79a, a second current sensor 79b, and a control unit 80.

The first power conversion apparatus 70 is connected to the first motor generator 22 and the connection port 26. The first power conversion apparatus 70 is capable of converting the power generated by the first motor generator 22 into single-phase alternating-current power and outputting the single-phase alternating-current power.

The second power conversion apparatus 72 is provided independently of the first power conversion apparatus 70. The second power conversion apparatus 72 is connected to the second motor generator 24 and the connection port 26. The second power conversion apparatus 72 is capable of converting the power generated by the second motor generator 24 into single-phase alternating-current power and outputting the single-phase alternating-current power. The second power conversion apparatus 72 outputs the single-phase alternating-current power different from the single-phase alternating-current power output from the first power conversion apparatus 70.

The connection port 26 has a first voltage terminal 90, a second voltage terminal 92, and a neutral terminal 94. The first voltage terminal 90 corresponds to a single-phase three-wire first voltage line. The second voltage terminal 92 corresponds to a single-phase three-wire second voltage line. The neutral terminal 94 corresponds to a single-phase three-wire neutral line.

A terminal corresponding to each of the first voltage terminal 90, the second voltage terminal 92, and the neutral terminal 94 of the connection port 26 is provided in the connector 40 of the power feeding cable 34 in the local facility 12. The respective terminals of the connector 40 are connected to the corresponding terminals of the connection port 26 to electrically connect the connection port 26 to the connector 40.

One of two output terminals of the first power conversion apparatus 70 is electrically connected to the first voltage terminal 90 of the connection port 26. The other of the two output terminals of the first power conversion apparatus 70 is electrically connected to the neutral terminal 94 of the connection port 26.

One of two output terminals of the second power conversion apparatus 72 is electrically connected to the second voltage terminal 92 of the connection port 26. The other of the two output terminals of the second power conversion apparatus 72 is electrically connected to the neutral terminal 94 of the connection port 26.

The first power conversion apparatus 70 and the second power conversion apparatus 72 are substantially capable of the single-phase three-wire output via the first voltage terminal 90, the second voltage terminal 92, and the neutral terminal 94.

The voltage of the first voltage terminal 90 based on the neutral terminal 94 may be hereinafter referred to as first voltage. The voltage of the second voltage terminal 92 based on the neutral terminal 94 may be hereinafter referred to as second voltage. In-between of the neutral terminal 94 and the first voltage terminal 90 may be hereinafter referred to as first in-between. In-between of the neutral terminal 94 and the second voltage terminal 92 may be hereinafter referred to as second in-between.

In the vehicle 10, control is performed so that the effective value of the first voltage is substantially equal to the effective value of the second voltage. In addition, in the vehicle 10, control is performed so that the phase of the first voltage is opposite to the phase of the second voltage.

The first power conversion apparatus 70 includes a first alternating current-direct current (ACDC) converter 100, a first direct current-direct current (DCDC) converter 102, and a first direct current-alternating current (DCAC) converter 104.

The first ACDC converter 100 converts three-phase alternating-current generated power of the first motor generator 22 into direct current power. The first ACDC converter 100 is composed of, for example, a three-phase diode bridge circuit included in an inverter.

The first DCDC converter 102 converts the direct current power after the conversion by the first ACDC converter 100 into direct current power of different voltage. The first DCDC converter 102 is, for example, a step-up step-down DCDC converter. The first DCDC converter 102 includes, for example, a switching element and is capable of outputting the direct current power of any voltage in response to control of the operation of the switching element under the control of the control unit 80.

The first DCAC converter 104 converts the power after the conversion by the first DCDC converter 102 into the single-phase alternating-current power. The first DCAC converter 104 supplies the single-phase alternating-current power subjected to the conversion between the neutral terminal 94 and the first voltage terminal 90. As a result, the first voltage is generated between the neutral terminal 94 and the first voltage terminal 90. The first DCAC converter 104 is composed of a single-phase inverter. The first DCAC converter 104 includes a switching element and is capable of generating the first voltage of any frequency in response to control of the operation of the switching element under the control of the control unit 80.

The second power conversion apparatus 72 includes a second ACDC converter 110, a second DCDC converter 112, and a second DCAC converter 114.

The second ACDC converter 110 converts three-phase alternating-current generated power of the second motor generator 24 into direct current power. The second ACDC converter 110 is composed of, for example, a three-phase diode bridge circuit included in an inverter.

The second DCDC converter 112 converts the power after the conversion by the second ACDC converter 110 into direct current power of different voltage. The second DCDC converter 112 is, for example, a step-up step-down DCDC converter. The second DCDC converter 112 includes, for example, a switching element and is capable of outputting the direct current power of any voltage in response to control of the operation of the switching element under the control of the control unit 80.

The second DCAC converter 114 converts the power after the conversion by the second DCDC converter 112 into the single-phase alternating-current power. The second DCAC converter 114 supplies the single-phase alternating-current power subjected to the conversion between the neutral terminal 94 and the second voltage terminal 92. As a result, the second voltage is generated between the neutral terminal 94 and the second voltage terminal 92. The second DCAC converter 114 is composed of a single-phase inverter. The second DCAC converter 114 includes a switching element and is capable of generating the second voltage of any frequency in response to control of the operation of the switching element under the control of the control unit 80.

The first voltage sensor 74 is capable of detecting the first voltage between the neutral terminal 94 and the first voltage terminal 90. The second voltage sensor 76 is capable of detecting the second voltage between the neutral terminal 94 and the second voltage terminal 92. The neutral line current sensor 78 is capable of detecting current flowing through the neutral terminal 94, that is, current flowing through the single-phase three-wire neutral line. The first current sensor 79a is capable of detecting current flowing through the first voltage terminal 90. The second current sensor 79b is capable of detecting current flowing through the second voltage terminal 92.

The control unit 80 includes one or more processors 120 and one or more memories 122 connected to the one or more processors 120. The memory 122 includes a read only memory (ROM) in which programs and so on are stored and a random access memory (RAM) serving as a working area. The processor 120 in the control unit 80 controls the entire vehicle 10 in cooperation with the programs included in the memory 122.

The processor 120 in the control unit 80 also serves as a power controller 130 that controls output of the power generated by the first motor generator 22 and the second motor generator 24 to the outside of the vehicle 10.

The power controller 130 controls one or more of the first DCAC converter 104 and the second DCAC converter 114 so that the frequency of the first voltage and the frequency of the second voltage are equal to the frequency of the power system 38.

The power controller 130 controls one or more of the first DCAC converter 104 and the second DCAC converter 114 so that the phase of the first voltage is opposite to the phase of the second voltage. At this time, the power controller 130 controls the first DCAC converter 104 and the second DCAC converter 114 so that the phase of the first voltage is synchronized with the phase of the first voltage line of the power system 38 and the phase of the second voltage is synchronized with the phase of the second voltage line of the power system 38.

The power controller 130 controls one or more of the first DCDC converter 102 and the second DCDC converter 112 so that the effective value of the first voltage is substantially equal to the effective value of the second voltage based on the result of detection by the first voltage sensor 74 and the result of detection by the second voltage sensor 76.

The power controller 130 controls one or more of the generated power of the first motor generator 22 and the generated power of the second motor generator 24 based on the ratio between the power of the first in-between and the power of the second in-between. For example, the power controller 130 controls one or more of the generated power of the first motor generator 22 and the generated power of the second motor generator 24 so that the ratio between the generated power of the first motor generator 22 and the generated power of the second motor generator 24 is substantially equal to the ratio between the power of the first in-between and the power of the second in-between. At this time, the power controller 130 may control the output from the engine 20 to control one or more of the rotation speed of the first motor generator 22 and the rotation speed of the second motor generator 24, thus controlling one or more of the generated power of the first motor generator 22 and the generated power of the second motor generator 24.

For example, the power controller 130 determines whether the power at the first voltage terminal 90 side is unbalanced with the power at the second voltage terminal 92 side based on the result of detection by the neutral line current sensor 78. For example, the power controller 130 may determine the unbalancing based on the current through the neutral terminal 94, which is detected by the neutral line current sensor 78.

The power controller 130 may determine the unbalancing from the power based on the result of detection by each of the first voltage sensor 74 and the first current sensor 79a and the power based on the result of detection by each of the second voltage sensor 76 and the second current sensor 79b.

If it is determined that the power at the first voltage terminal 90 side is not unbalanced with the power at the second voltage terminal 92 side, that is, the power at the first voltage terminal 90 side is balanced with the power at the second voltage terminal 92 side, the power of the first in-between and the power of the second in-between are considered to substantially have a ratio of 1:1. In this case, the power controller 130, for example, controls the output from the engine 20 to perform control so that the generated power of the first motor generator 22 is equal to the generated power of the second motor generator 24. For example, the power controller 130 performs control so that both the generated power of the first motor generator 22 and the generated power of the second motor generator 24 have a maximum value of “3,000 VA”.

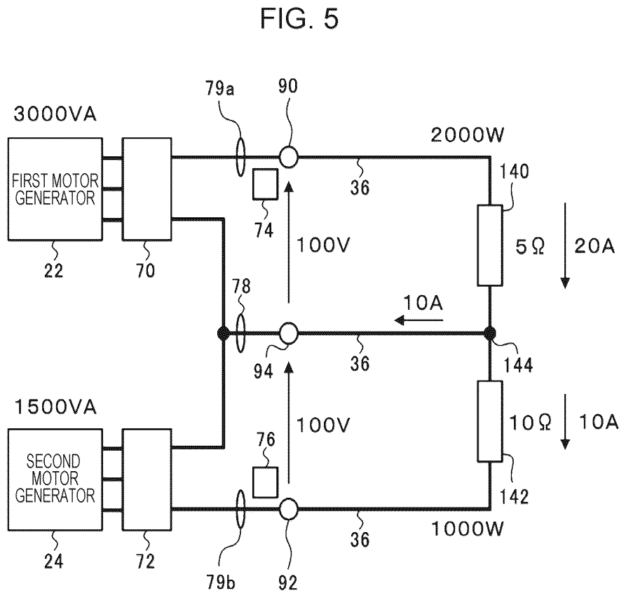

FIG. 5 is a diagram describing how to perform control if it is determined that the power at the first voltage terminal 90 side is unbalanced with the power at the second voltage terminal 92 side. An example is described in FIG. 5 in which a first resistor 140 having a resistance value of 5Ω is connected between the neutral terminal 94 and the first voltage terminal 90 as a load in the premise and a second resistor 142 having a resistance value of 10Ω is connected between the neutral terminal 94 and the second voltage terminal 92 as a load in the premise. A point at which the first resistor 140 and the second resistor 142 are connected to the neutral line is referred to as a neutral point 144. It is assumed that the first voltage is 100 V and the second voltage is 100 V.

In this example, current of 20 A flows through the first resistor 140 and current of 10 A flows through the second resistor 142, as illustrated in FIG. 5. At this time, current of 10 A flows through the neutral line in a direction from the neutral point 144 to the neutral terminal 94. In other words, since the current through the neutral line is not zero, the power at the first voltage terminal 90 side is unbalanced with the power at the second voltage terminal 92 side. In this example, the power between the neutral terminal 94 and the first voltage terminal 90 with the first resistor 140 connected therebetween is “2,000 W” and the power between the neutral terminal 94 and the second voltage terminal 92 with the second resistor 142 connected therebetween is “1,000 W”. Accordingly, the power at the first voltage terminal 90 side is higher than the power at the second voltage terminal 92 side.

If it is determined that the power at the first voltage terminal 90 side is unbalanced with the power at the second voltage terminal 92 side, the power controller 130 derives the ratio between the power of the first in-between and the power of the second in-between based on the current value detected by the first current sensor 79a, the current value detected by the second current sensor 79b, the voltage value detected by the first voltage sensor 74, and the voltage value detected by the second voltage sensor 76. In the example in FIG. 5, the power controller 130 derives the power of the first in-between “2,000 W” from the “20 A”, which is the result of detection by the first current sensor 79a, and “100 V”, which is the result of detection by the first voltage sensor 74. The power controller 130 derives the power of the second in-between “1,000 W” from the “10 A”, which is the result of detection by the second current sensor 79b, and “100 V”, which is the result of detection by the second voltage sensor 76. The power controller 130 derives the ratio “2:1” between the power of the first in-between and the power of the second in-between from “2,000 W” and “1,000 W”, which are derived.

The power controller 130 controls the generated power of the first motor generator 22 and the generated power of the second motor generator 24 so that the ratio between the generated power of the first motor generator 22 and the generated power of the second motor generator 24 is substantially equal to the ratio between the power of the first in-between and the power of the second in-between, which are derived. In the example in FIG. 5, since the ratio between the power of the first in-between and the power of the second in-between is “2:1”, as described above, for example, the generated power of the first motor generator 22 is set to “3,000 VA” and the generated power of the second motor generator 24 is set to “1,500 VA” so that the ratio between the generated power of the first motor generator 22 and the generated power of the second motor generator 24 is “2:1”.

For example, the power controller 130 sets the generated power of the motor generator having the higher value in the ratio, among the first motor generator 22 and the second motor generator 24, to maximum power of the motor generator having the higher value in the ratio. Then, the power controller 130 determines the generated power of the motor generator having the lower value in the ratio based on the generated power of the motor generator having the higher value in the ratio, that is, the maximum power of the motor generator having the higher value in the ratio, among the first motor generator 22 and the second motor generator 24. In the example in FIG. 5, since the ratio between the generated power of the first motor generator 22 and the generated power of the second motor generator 24 is “2:1” and the first motor generator 22 has the higher value in the ratio, the generated power of the first motor generator 22 is set to “3,000 VA”, which is the maximum power of the first motor generator 22. Since the ratio between the generated power of the first motor generator 22 and the generated power of the second motor generator 24 is “2:1”, the generated power of the second motor generator 24 is set to “1,500 VA”, which is half of the generated power “3,000 VA” of the first motor generator 22, based on the generated power of the first motor generator 22.

As described above, when the power at the first voltage terminal 90 side is unbalanced with the power at the second voltage terminal 92 side, the generated power of the motor generator having the lower value in the ratio between the power of the first in-between and the power of the second in-between, among the first motor generator 22 and the second motor generator 24, is suppressed. As a result, it is possible to suppress excessive power generation in the motor generator having the lower value in the ratio between the power of the first in-between and the power of the second in-between.

If excessive power generation is performed, the power that is excessively generated is converted into heat in the motor generator, the power conversion apparatus, or the like. It takes a further amount of energy to reduce the generated heat. Since the excessive power generation is suppressed in the power supply system 1, it is possible to suppress the wasted energy caused by the excessive power generation.

In the determination of the generated power, if the generated power of the motor generator having the lower value in the ratio, among the first motor generator 22 and the second motor generator 24, exceeds the maximum power of the motor generator having the lower value in the ratio, the power controller 130 may set the generated power of the motor generator having the lower value in the ratio as the maximum power of the motor generator having the lower value in the ratio to restrict the generated power of the motor generator having the higher value in the ratio based on the generated power of the motor generator having the lower value in the ratio.

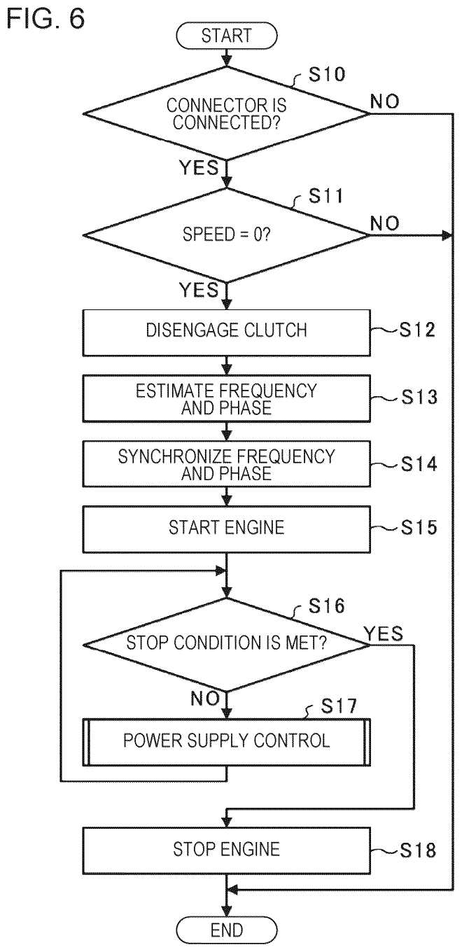

FIG. 6 is a flowchart describing an operational flow of the power controller 130. In Step S10, the power controller 130 periodically determines whether the connector 40 of the power feeding cable 34 is connected to the connection port 26. If the power controller 130 determines that the connector 40 of the power feeding cable 34 is not connected to the connection port 26 (NO in Step S10), the power controller 130 waits for connection of the connector 40. If the power controller 130 determines that the connector 40 of the power feeding cable 34 is connected to the connection port 26 (YES in Step S10), the power controller 130 performs Steps S11 and the subsequent steps.

In Step S11, the power controller 130 determines whether the speed of the vehicle 10 is substantially zero, that is, whether the vehicle 10 is not running. If the power controller 130 determines that the vehicle 10 is running (NO in Step S11), the power controller 130 terminates the series of steps in FIG. 6.

If the power controller 130 determines that the vehicle 10 is not running (YES in Step S11), in Step S12, the power controller 130 causes the clutch 54 to be in the disengaged state.

In Step S13, the power controller 130 estimates the frequency of the voltage of the power system 38 and the phase of the power of the power system 38. For example, before the connector 40 is connected to start supply of the power to the outside of the vehicle 10, the power of the power system 38 is supplied to the first power conversion apparatus 70 and the second power conversion apparatus 72 via the connector 40. The power controller 130 acquires and analyzes the power supplied from the power system 38 to estimate the frequency and the phase. For example, the power controller 130 may estimate the frequency from the period of the zero point on the voltage of the power system 38 and may estimate the phase from the timing of the zero point on the power of the power system 38.

In Step S14, the power controller 130 sets the content of control so that the frequencies of the voltages output from the first DCAC converter 104 and the second DCAC converter 114 are synchronized with the estimated frequency. In addition, the power controller 130 sets the content of control so that the phases of the powers output from the first DCAC converter 104 and the second DCAC converter 114 are synchronized with the estimated phase.

For example, when power outage occurs in the power system 38, the power controller 130 may omit the synchronization of the frequency and the phase with those of the power system 38 to use a frequency and a phase that are set in advance.

In Step S15, the power controller 130 starts the engine 20. This causes the first motor generator 22 and the second motor generator 24 to start the power generation.

In Step S16, the power controller 130 determines whether a predetermined stop condition to stop the engine 20 is met. An appropriate condition, such as an instruction to terminate the supply of the power to the outside of the vehicle 10, may be set as the stop condition here.

If the power controller 130 determines that the stop condition is not met (NO in Step S16), the power controller 130 repeatedly performs power supply control (Step S17) to control the power to be supplied to the outside of the vehicle 10. The power supply control (Step S17) will be described in detail below.

If the power controller 130 determines that the stop condition is met (YES in Step S16), in Step S18, the power controller 130 stops the engine 20. Then, the power controller 130 terminates the series of steps in FIG. 6.

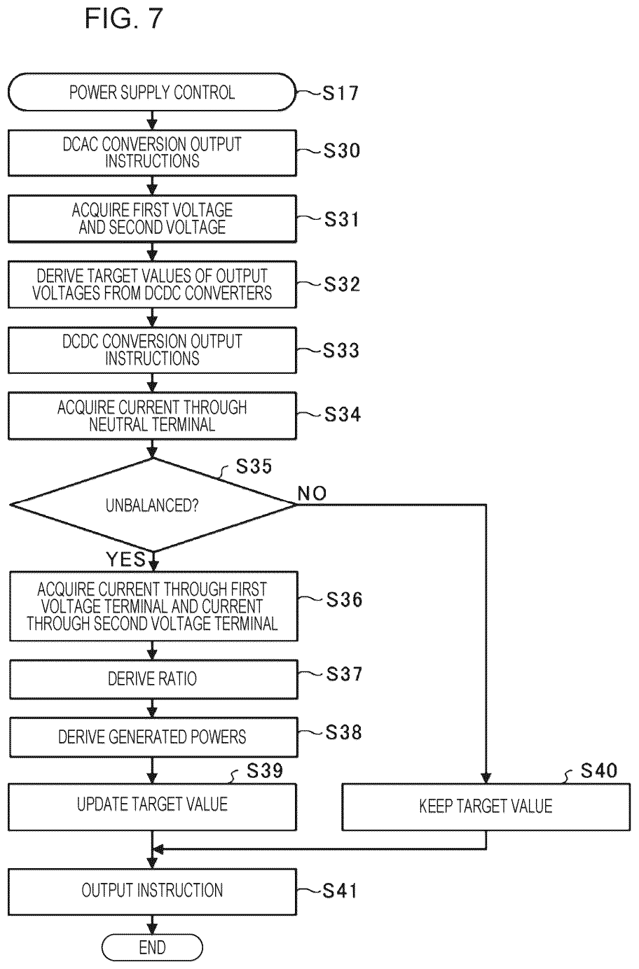

FIG. 7 is a flowchart describing an operational flow of the power supply control (Step S17). In Step S30, the power controller 130 generates a first DCAC conversion output instruction instructing the operation of the first DCAC converter 104 to transmit the first DCAC conversion output instruction to the first DCAC converter 104. In addition, the power controller 130 generates a second DCAC conversion output instruction instructing the operation of the second DCAC converter 114 to transmit the second DCAC conversion output instruction to the second DCAC converter 114. The first DCAC conversion output instruction and the second DCAC conversion output instruction each include instruction information about the frequency and the phase that are set. The first DCAC converter 104 and the second DCAC converter 114 operate in accordance with the first DCAC conversion output instruction and the second DCAC conversion output instruction, respectively, which are received.

In Step S31, the power controller 130 acquires the first voltage detected by the first voltage sensor 74 and the second voltage detected by the second voltage sensor 76.

In Step S32, the power controller 130 derives a target value of output voltage from the first DCDC converter 102 based on the acquired first voltage. In addition, the power controller 130 derives a target value of output voltage from the second DCDC converter 112 based on the acquired second voltage.

In Step S33, the power controller 130 generates a first DCDC conversion output instruction instructing the target value of the output voltage from the first DCDC converter 102 to transmit the first DCDC conversion output instruction to the first DCDC converter 102. In addition, the power controller 130 generates a second DCDC conversion output instruction instructing the target value of the output voltage from the second DCDC converter 112 to transmit the second DCDC conversion output instruction to the second DCDC converter 112. The first DCDC converter 102 and the second DCDC converter 112 operate in accordance with the first DCDC conversion output instruction and the second DCDC conversion output instruction, respectively, which are received.

In Step S34, the power controller 130 acquires the current through the neutral terminal 94 detected by the neutral line current sensor 78. In Step S35, the power controller 130 determines whether the power between the neutral terminal 94 and the first voltage terminal 90 is unbalanced with the power between the neutral terminal 94 and the second voltage terminal 92 based on the current through the neutral terminal 94, which is acquired. For example, when the acquired current through the neutral terminal 94 is not substantially zero, the power controller 130 may determine that the power between the neutral terminal 94 and the first voltage terminal 90 is unbalanced with the power between the neutral terminal 94 and the second voltage terminal 92.

If the power controller 130 determines that the power between the neutral terminal 94 and the first voltage terminal 90 is unbalanced with the power between the neutral terminal 94 and the second voltage terminal 92 (YES in Step S35), in Step S36, the power controller 130 acquires the current through the first voltage terminal 90, which is detected by the first current sensor 79a, and the current through the second voltage terminal 92, which is detected by the second current sensor 79b.

In Step S37, the power controller 130 derives the ratio between the power of the first in-between and the power of the second in-between based on the current through the first voltage terminal 90 and the current through the second voltage terminal 92, which are acquired in Step S36, and the first voltage and the second voltage, which are acquired in Step S31.

In Step S38, the power controller 130 derives the generated power of the first motor generator 22 and the generated power of the second motor generator 24 so that the ratio between the generated power of the first motor generator 22 and the generated power of the second motor generator 24 is substantially equal to the derived ratio.

In Step S39, the power controller 130 updates the target value of the output from the engine 20 so that the generated power of the first motor generator 22 and the generated power of the second motor generator 24 are equal to the derived generated power. Then, the power controller 130 goes to Step S41.

If the power controller 130 determines that the power between the neutral terminal 94 and the first voltage terminal 90 is not unbalanced, that is, is balanced with the power between the neutral terminal 94 and the second voltage terminal 92 (NO in Step S35), in Step S40, the power controller 130 keeps the target value of the output from the engine 20 at a value that is currently set. Then, the power controller 130 goes to Step S41.

In Step S41, the power controller 130 generates an engine output instruction instructing the target value of the output from the engine 20, which is set in Step S39 or Step S40, to transmit the engine output instruction to the engine 20. The engine 20 operates in accordance with the received engine output instruction.

As described above, the vehicle 10 of the present embodiment includes the first power conversion apparatus 70 capable of conversion into the single-phase alternating-current power and output of the single-phase alternating-current power and the second power conversion apparatus 72 capable of conversion into the single-phase alternating-current power and output of the single-phase alternating-current power. In the vehicle 10 of the present embodiment, one of the two output terminals of the first power conversion apparatus 70 is electrically connected to the first voltage terminal 90 of the connection port 26 and the other thereof is electrically connected to the neutral terminal 94 of the connection port 26. In the vehicle 10 of the present embodiment, one of the two output terminals of the second power conversion apparatus 72 is electrically connected to the second voltage terminal 92 of the connection port 26 and the other thereof is electrically connected to the neutral terminal 94 of the connection port 26.

With this configuration, in the vehicle 10 of the present embodiment, the power between the neutral terminal 94 and the second voltage terminal 92, which is generated by the second motor generator 24, is also capable of being supplied to the outside of the vehicle 10, in addition to the power between the neutral terminal 94 and the first voltage terminal 90, which is generated by the first motor generator 22. Accordingly, in the vehicle 10 of the present embodiment, it is possible to supply a larger amount of power to the outside of the vehicle 10, compared with a configuration in which the generated power of one motor generator is supplied to the outside of the vehicle 10.

Consequently, with the vehicle 10 of the present embodiment, it is possible to supply a sufficient amount of power to the outside of the vehicle 10.

In addition, the first power conversion apparatus 70 and the second power conversion apparatus 72 in the vehicle 10 of the present embodiment are substantially capable of the single-phase three-wire output via the first voltage terminal 90, the second voltage terminal 92, and the neutral terminal 94.

In the single-phase three-wire method, third voltage between the first voltage terminal 90 and the second voltage terminal 92 is also capable of being used, in addition to the first voltage between the neutral terminal 94 and the first voltage terminal 90 and the second voltage between the neutral terminal 94 and the second voltage terminal 92. Accordingly, with the vehicle 10 of the present embodiment, it is possible to supply a further sufficient amount of power to the outside of the vehicle 10.

The common consumer receives the power from the power system 38 using the single-phase three-wire power distribution method. Accordingly, the local wiring 36 of the consumer is configured on the premise of the single-phase three-wire method. Since the single-phase three-wire output is enabled in the vehicle 10 of the present embodiment, the vehicle 10 of the present embodiment has high compatibility with the local wiring 36 of the consumer and it is possible to more appropriately supply the power to the local wiring 36 of the consumer.

Since the vehicle 10 of the present embodiment is capable of the single-phase three-wire output, it is not necessary to provide another power conversion apparatus between the vehicle 10 and the local wiring 36 in the supply of the power to the local wiring 36 of the consumer and it is possible to directly supply the power to the local wiring 36. Accordingly, the user friendliness is high in the vehicle 10 of the present embodiment. In addition, since it is not necessary to provide another power conversion apparatus in the vehicle 10 of the present embodiment, it is possible to avoid power loss in the other power conversion apparatus. Furthermore, in the vehicle 10 of the present embodiment, it is not necessary to ensure the space in which the other power conversion apparatus is disposed and it is possible to reduce the cost to install the other power conversion apparatus.

In a configuration in a comparative example in which the first motor generator 22 is caused to generate the power via the planetary mechanism 50 in accordance with the operation of the engine 20, the efficiency of converting the output from the engine 20 into the rotation of the first motor generator 22 is low and the amount of generated power with respect to the output from the engine 20 is small.

In contrast, in the vehicle 10 of the present embodiment, the output from the engine 20 is distributed to the first motor generator 22 and the second motor generator 24 via the planetary mechanism 50 to cause the first motor generator 22 and the second motor generator 24 to generate the power. In order to realize this, the vehicle 10 of the present embodiment includes the clutch 54. With such a configuration, in the vehicle 10 of the present embodiment, the efficiency of the rotation of the first motor generator 22 and the second motor generator 24 with respect to the output from the engine 20 is higher than that of the comparative example described above in which the first motor generator 22 is caused to generate the power. Accordingly, with the vehicle 10 of the present embodiment, it is possible to cause the first motor generator 22 and the second motor generator 24 to efficiently generate the power while suppressing the output from the engine 20.

The vehicle 10 of the present embodiment includes the decelerator 52. With this configuration, in the vehicle 10 of the present embodiment, the generated power of the first motor generator 22 is capable of being substantially equal to the generated power of the second motor generator 24 even if the specifications of the first motor generator 22 are different from the specifications of the second motor generator 24. As a result, with the vehicle 10 of the present embodiment, it is possible to appropriately perform the single-phase three-wire output.

Although the embodiments of the disclosure are described above with reference to the accompanying drawings, the disclosure is not limited to the embodiments. Those skilled in the art will recognize that the disclosure can be practiced with various modifications and changes without departing from the true spirit and scope of the disclosure and the modifications and changes belong to the technical range of the disclosure.

According to the disclosure, it is possible to supply a sufficient amount of power.

The control unit 80 illustrated in FIG. 4 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control unit 80 including the one or more processors 120, the power controller 130, and the one or more memories 122. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 4.

1. A vehicle comprising:
a first motor generator;
a second motor generator;
a first power conversion apparatus configured to convert power generated by the first motor generator into single-phase alternating-current power and output the single-phase alternating-current power;
a second power conversion apparatus provided independently of the first power conversion apparatus and configured to convert power generated by the second motor generator into single-phase alternating-current power and output the single-phase alternating-current power;
a connection port comprising a first voltage terminal, a second voltage terminal, and a neutral terminal, the connection port being configured to electrically connected to wiring outside the vehicle;
a planetary mechanism comprising a sun gear, a ring gear, a planetary pinion, and a carrier coupled to the planetary pinion;
an engine configured to be connected to the carrier;
a clutch; and
wheels,
wherein a first output terminal of two output terminals of the first power conversion apparatus is configured to be electrically connected to the first voltage terminal of the connection port and a second output terminal of the two output terminals of the first power conversion apparatus is configured to be electrically connected to the neutral terminal of the connection port,
wherein a first output terminal of two output terminals of the second power conversion apparatus is configured to be electrically connected to the second voltage terminal of the connection port and a second output terminal of two output terminals of the second power conversion apparatus is configured to be electrically connected to the neutral terminal of the connection port,
wherein the second motor generator is connected to the ring gear and is connected to a first end of the clutch,
wherein a second end of the clutch is connected to the wheels,
wherein the second motor generator is configured to generate the power in accordance with an operation of the engine, and
wherein the clutch is configured to, when the second motor generator is caused to generate the power in a state in which the vehicle is not running, be caused to be in a disengaged state.

2. A vehicle comprising:
a first motor generator;
a second motor generator;
a first power conversion apparatus configured to convert power generated by the first motor generator into single-phase alternating-current power and output the single-phase alternating-current power;
a second power conversion apparatus provided independently of the first power conversion apparatus and configured to convert power generated by the second motor generator into single-phase alternating-current power and output the single-phase alternating-current power;
a connection port comprising a first voltage terminal, a second voltage terminal, and a neutral terminal, the connection port being configured to be electrically connected to wiring outside the vehicle;
a planetary mechanism comprising a sun gear, a ring gear, a planetary pinion, and a carrier coupled to the planetary pinion;
an engine configured to be connected to the carrier; and
a decelerator configured to be connected to the ring gear,
wherein a first output terminal of two output terminals of the first power conversion apparatus is configured to be electrically connected to the first voltage terminal of the connection port and a second output terminal of the two output terminals of the first power conversion apparatus is configured to be electrically connected to the neutral terminal of the connection port,
wherein a first output terminal of two output terminals of the second power conversion apparatus is configured to be electrically connected to the second voltage terminal of the connection port and a second output terminal of the two output terminals of the second power conversion apparatus is configured to be electrically connected to the neutral terminal of the connection port,
wherein the first motor generator is connected to the sun gear,
wherein the second motor generator is connected to the ring gear via the decelerator,
wherein the first motor generator and the second motor generator are configured to generate the power in accordance with an operation of the engine, and
wherein a gear ratio of the decelerator is set to a value at which a difference between a maximum value of the power which the first motor generator is capable of generating and a maximum value of the power which the second motor generator is capable of generating is substantially decreased.

3. A vehicle comprising:
a first motor generator;
a second motor generator;
a first power conversion apparatus configured to convert power generated by the first motor generator into single-phase alternating-current power and output the single-phase alternating-current power;
a second power conversion apparatus provided independently of the first power conversion apparatus and configured to convert power generated by the second motor generator into single-phase alternating-current power and output the single-phase alternating-current power;
a connection port comprising a first voltage terminal, a second voltage terminal, and a neutral terminal, the connection port being configured to be electrically connected to wiring outside the vehicle;
a first voltage sensor configured to perform detection of voltage between the neutral terminal and the first voltage terminal;
a second voltage sensor configured to perform detection of voltage between the neutral terminal and the second voltage terminal; and
a control unit,
wherein a first output terminal of two output terminals of the first power conversion apparatus is configured to be electrically connected to the first voltage terminal of the connection port and a second output terminal of the two output terminals of the first power conversion apparatus is configured to be electrically connected to the neutral terminal of the connection port,
wherein a first output terminal of two output terminals of the second power conversion apparatus is configured to be electrically connected to the second voltage terminal of the connection port and a second output terminal of the two output terminals of the second power conversion apparatus is configured to be electrically connected to the neutral terminal of the connection port,
wherein the first power conversion apparatus comprises
a first alternating current-direct current converter configured to perform conversion of alternating-current generated power of the first motor generator into direct current power,
a first direct current-direct current converter configured to perform conversion of the direct current power after the conversion by the first alternating current-direct current converter into direct current power of different voltage, and
a first direct current-alternating current converter configured to perform conversion of the direct current power after the conversion by the first direct current-direct current converter into single-phase alternating-current power and configured to supply the single-phase alternating-current power after the conversion between the neutral terminal and the first voltage terminal,
wherein the second power conversion apparatus comprises
a second alternating current-direct current converter configured to perform conversion of alternating-current generated power of the second motor generator into direct current power,
a second direct current-direct current converter configured to perform conversion of the direct current power after the conversion by the second alternating current-direct current converter into direct current power of different voltage, and
a second direct current-alternating current converter configured to perform conversion of the direct current power after the conversion by the second direct current-direct current converter into single-phase alternating-current power and configured to supply the single-phase alternating-current power after the conversion between the neutral terminal and the second voltage terminal,
wherein the control unit comprises
one or more processors, and
one or more memories coupled to the one or more processors, and
wherein the one or more processors are configured to control one or both of the first direct current-direct current converter and the second direct current-direct current converter so that an effective value of voltage between the neutral terminal and the first voltage terminal is substantially equal to an effective value of voltage between the neutral terminal and the second voltage terminal based on a result of the detection by the first voltage sensor and a result of the detection by the second voltage sensor.

4. A vehicle comprising:
a first motor generator;
a second motor generator;
a first power conversion apparatus configured to convert power generated by the first motor generator into single-phase alternating-current power and output the single-phase alternating-current power;
a second power conversion apparatus provided independently of the first power conversion apparatus and configured to convert power generated by the second motor generator into single-phase alternating-current power and output the single-phase alternating-current power;
a connection port comprising a first voltage terminal, a second voltage terminal, and a neutral terminal, the connection port being configured to be electrically connected to wiring outside the vehicle; and
a control unit,
wherein a first output terminal of two output terminals of the first power conversion apparatus is configured to be electrically connected to the first voltage terminal of the connection port and a second output terminal of the two output terminals of the first power conversion apparatus is configured to be electrically connected to the neutral terminal of the connection port,
wherein a first output terminal of two output terminals of the second power conversion apparatus is configured to be electrically connected to the second voltage terminal of the connection port and a second output terminal of the two output terminals of the second power conversion apparatus is configured to be electrically connected to the neutral terminal of the connection port,
wherein the control unit comprises
one or more processors, and
one or more memories coupled to the one or more processors, and
wherein the one or more processors are configured to perform processes comprising
determining whether power of first in-between between the neutral terminal and the first voltage terminal is unbalanced with power of second in-between between the neutral terminal and the second voltage terminal, and
when the power of the first in-between is unbalanced with the power of the second in-between, controlling one or both of generated power of the first motor generator and generated power of the second motor generator so that a ratio between the generated power of the first motor generator and the generated power of the second motor generator is substantially equal to a ratio between the power of the first in-between and the power of the second in-between.
